(19) United States
(12) Patent Application Publication
(10) Pub. No.: US 2016/0132980 A1
(43) Pub. Date: May 12, 2016

(54) Techniques for Managing External Learning Content

(71) Applicants: Joseph Herman, McLean, VA (US); Sany Said, Clifton, VA (US)

(72) Inventors: Joseph Herman, McLean, VA (US); Sany Said, Clifton, VA (US)

(21) Appl. No.: 14/574,105

(22) Filed: Dec. 17, 2014

Related U.S. Application Data
(60) Provisional application No. 62/078,520, filed on Nov. 12, 2014.

(51) Int. Cl. G06Q 50/20; G06Q 10/10

(52) U.S. Cl. CPC G06Q 50/2057; G06Q 10/10

(57) ABSTRACT

A framework for facilitating the management of, and access to, external learning content within an organization is provided. In various embodiments, a computer system (or group of computer systems) implementing the framework can, e.g.: (1) import, into the organization's learning management system (LMS), metadata for external learning content items provided by an external content provider; (2) enable an organization administrator to assign each of the external learning content items to one or more users or programs/catalogs/curricula in the organization; (3) enable organization users to search for and launch their assigned external learning content items directly from the LMS; (4) automatically log the organization users into the external content provider systems as part of the item launch process; and (5) automatically track completion of the external learning content items.

### CROSS REFERENCES TO RELATED APPLICATIONS

The present application claims the benefit and priority under 35 U.S.C. 119(e) of U.S. Provisional Application No. 62/078,520, filed Nov. 12, 2014, entitled “OPEN CONTENT NETWORK.” The entire contents of this provisional application are incorporated herein by reference for all purposes.

### BACKGROUND

Traditionally, organizations seeking to provide learning content (e.g., online courses, electronic learning materials, etc.) to their employees/users have either (1) internally developed such content, or (2) contracted with external content providers to provide such content for internal use. With option (1) (i.e., internal content development), organizations can create original learning plans that are closely tailored to their users' needs and interests. However, internal content development can be costly and may require experts/staff that are not available internally, or are already over-committed to other projects.

Option (2) (i.e., contracted external learning) allows organizations to leverage the large amounts of learning content that have been developed by external providers (often with the help of leading subject matter experts in their respective fields), without incurring internal overhead or development costs. Thus, contracted external learning can be preferable to internal content development in many scenarios. However, one problem with this option is that, in existing implementations, external learning content is typically not integrated with organizations' internal information technology (IT) systems. Accordingly, organization users that are interested in finding and consuming such external content must do so independently by, e.g., performing a Web search, navigating to the provider's external website or portal, creating an account specific to that provider, and then accessing the desired content. This process is cumbersome and inefficient, particularly in organizations that have invested heavily in centralized learning/training management systems that are intended to standardize access, assignment, and reporting of user learning.

### SUMMARY

A framework for facilitating the management of, and access to, external learning content within an organization is provided. In various embodiments, a computer system (or group of computer systems) implementing the framework can, e.g.: (1) import, into the organization's learning management system (LMS), metadata for external learning content items provided by an external content provider; (2) enable an organization administrator to assign each of the external learning content items to one or more users or programs/catalogs/curricula in the organization; (3) enable organization users to search for and launch their assigned external learning content items directly from the LMS; (4) automatically log the organization users into the external content provider systems as part of the item launch process; and (5) automatically track completion of the external learning content items.

The following detailed description and accompanying drawings provide a better understanding of the nature and advantages of particular embodiments.

### BRIEF DESCRIPTION OF DRAWINGS

FIG. 1 depicts a system environment according to an embodiment.

FIG. 2 depicts a flowchart for importing external learning content items and assigning the external content items to users/catalogs/programs/curricula according to an embodiment.

FIG. 3 depicts a user interface (UI) for enabling external learning content for an LMS instance according to an embodiment.

FIG. 4 depicts a UI for managing content synchronization settings according to an embodiment.

FIG. 5 depicts an administrator-level UI for searching for external learning content items according to an embodiment.

FIG. 6 depicts a UI displaying a list of external learning content items retrieved using the search interface of FIG. 5 according to an embodiment.

FIG. 7 depicts a flowchart for enabling an organization user to find and launch external learning content items according to an embodiment.

FIG. 8 depicts a user-level UI for searching for external learning content items according to an embodiment.

FIG. 9 depicts a flowchart for automatically logging an organization user into an external content provider system at the time of launching an external learning content item according to an embodiment.

FIG. 10 depicts a flowchart for automatically tracking a completed external learning content item according to an embodiment.

FIG. 11 depicts a computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

Embodiments of the present disclosure provide a framework (referred to herein as the “Open Content Network” framework, or “OCN”) that enables an organization to easily aggregate, manage, and deliver external learning content to its users. Examples of such learning content include massively open online courses (MOOCs), various types of learning materials (e.g., textbooks, lecture videos or recordings, problem sets, etc.), and so on. With this framework, the organization can take advantage of the wide range of professionally developed learning content that is available from external content providers, rather than having to internally recreate the same or similar content.

Significantly, the OCN framework integrates the management of, and access to, the external learning content directly into the organization's central learning/training management system (referred to herein as an “LMS”). For instance, in one set of embodiments, OCN enables an organization administrator to search for and find all of the learning content available from one or more external content providers and choose to import content of interest into an LMS database. Once imported, the administrator can assign external learning content items to, e.g., LMS course catalogs, assignment profiles, programs, curricula, and/or users/user groups. OCN further enables organization users to search for and find the assigned external learning content items through a user-level UI of the LMS, in a manner similar to searching for internally-developed learning content. Users can then choose to launch an external learning content item (e.g., a course) directly from the LMS, and thereby open the content item directly at the content provider's site without having to separately search and navigate to the provider's site.

In certain embodiments, when a user launches an external learning content item (e.g., an online course hosted at an external content provider's website), OCN can automatically handle the process of logging the user into the external content provider's system by integrating with an Identity Provider (IDP) used by the LMS during the LMS login process. For example, assume that the user has already logged into the LMS via his or her employee credentials. At the point of launching the external learning content item, the IDP associated with the LMS can transparently provide the user's credentials that were captured during the LMS login process to the external content provider. The external content provider can then attempt to authenticate the user against the provider's user database using these credentials and, if the authentication is successful, automatically login the user. In addition, if the user does not yet have an account with the external content provider, a new account can be automatically created using the received credentials. In this way, OCN can streamline and simplify user access to external content.

In further embodiments, when a user has completed an external learning content item (e.g., completed an online course), OCN can enable this completion information to be automatically communicated from the external content provider to the LMS (via either a push or pull mechanism). LMS can then maintain the completion information for reporting and record keeping purposes. Thus, OCN allows for seamless tracking of user learning history, regardless of whether the consumed learning content is external or internal to the organization.

These and other aspects of the present disclosure are described in further detail in the sections that follow.

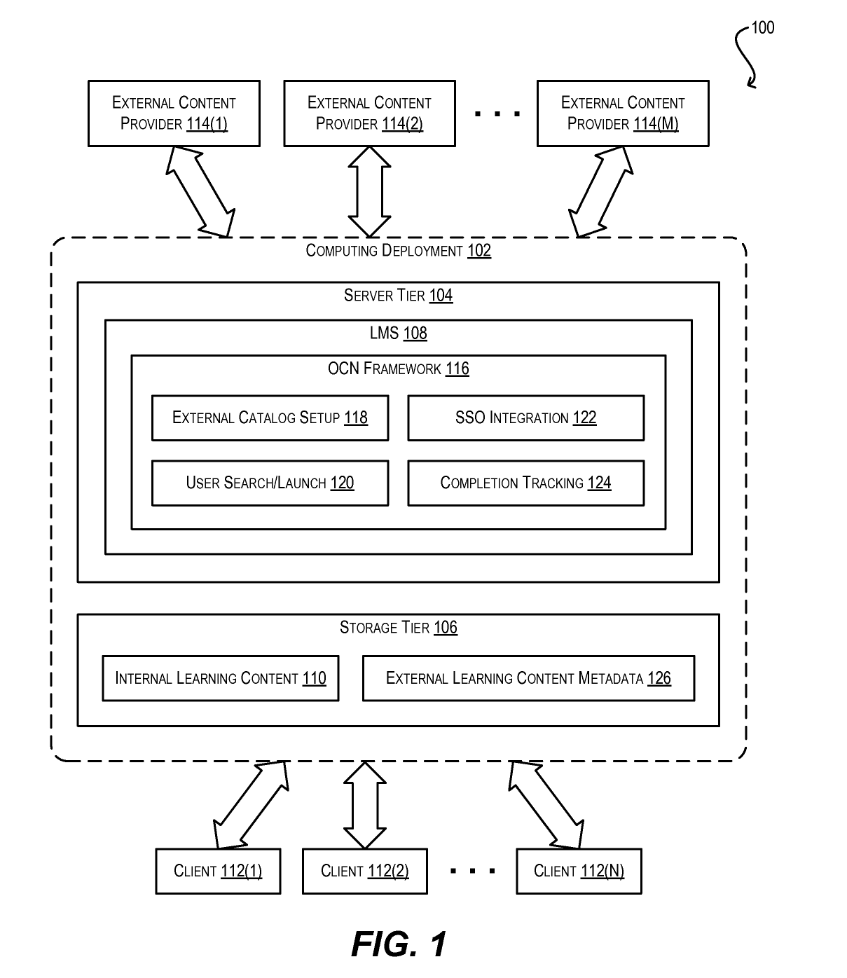

FIG. 1 depicts a system environment 100 that implements the OCN framework according to an embodiment. As shown, system environment includes a computing deployment 102 comprising a server tier 104 and a storage tier 106. Server tier 104, which can be implemented using one or physical computer systems, is configured to run a central learning/training management software system (i.e., LMS) 108 for an organization. An example of such an LMS is SuccessFactors' Learning Management System. Storage tier 106, which can be implemented using one or more physical storage components (e.g., dedicated storage arrays, commodity hard/flash disks, etc.), is configured to maintain persistent data on behalf of LMS 108, such as internally-developed learning content 110. LMS 108 can make this content available to organization users operating client devices 112(1)-112(N), such that those users can search for and consume the content.

System environment 100 further includes a number of external content provider systems 114(1)-114(M). These external content providers can comprise providers that have contracted with the organization associated with computing deployment 102 in order to provide external learning content to the organization's users. These external content providers can also comprise providers that do not have a specific agreement with the organization, but make their content generally available to the public via, e.g., the Web. Examples of external content providers include, e.g., Lynda.com, Coursera, OpenHPI, Udacity, and the like.

As noted in the Background section, one problem with existing LMS implementations is that they do not integrate external learning content (such as the content provided by external content provider systems 114(1)-114(M)) for easy access and management of such content. This means that, even if an organization has contracted with an external content provider to provide certain external courses to the organization's users, the users would need to independently find and consume those courses (via, e.g., the Web), rather than being able to access it directly from the organization's LMS. Further, the users would need to independently and manually keep track of the external courses they have completed, since the LMS has no knowledge of that external content and how it is linked to the users.

To address these and other similar problems, LMS 108 includes a novel OCN framework 116 which comprises an external catalog setup component 118, a user search/launch component 120, an SSO integration component 122, and a completion tracking component 124. As described in further detail below, these components of OCN framework 116 can enable LMS 108 to, inter alia: (1) import metadata regarding external learning content from external content provider systems 114(1)-114(M) into local storage (shown as external learning content metadata 126 in storage tier 106); (2) make the imported content items available to organization users (e.g., via assignment to specific users or internally-defined catalogs, programs, or curricula); (3) allow users to search for and launch the external learning content items directly from the LMS UI; (4) automate the login process when a user accesses an external learning content item from the LMS UI; and (5) automatically track the completion of external learning content items. In this manner, OCN framework 116 can streamline and simplify external learning content management/access for both administrators and end-users of the organization.

It should be appreciated that system environment 100 is illustrative and not intended to limit the embodiments discussed herein. For example, in some embodiments, system environment 100 may include a centralized OCN database that is shared by multiple organizations. In these embodiments, content from external content provider systems 114(1)-114(M) may be aggregated into the centralized OCN database, and then various organizations (each with their own LMS deployments) may interact with the centralized OCN database to import this content (rather than importing the content directly from external content provider systems 114(1)-114(M)).

Further, while system environment 100 depicts a particular configuration of entities and components, other configurations (with certain entities/components being combined or split into sub-entities or subcomponents) are also possible. One of ordinary skill in the art will recognize many variations, modifications, and alternatives.

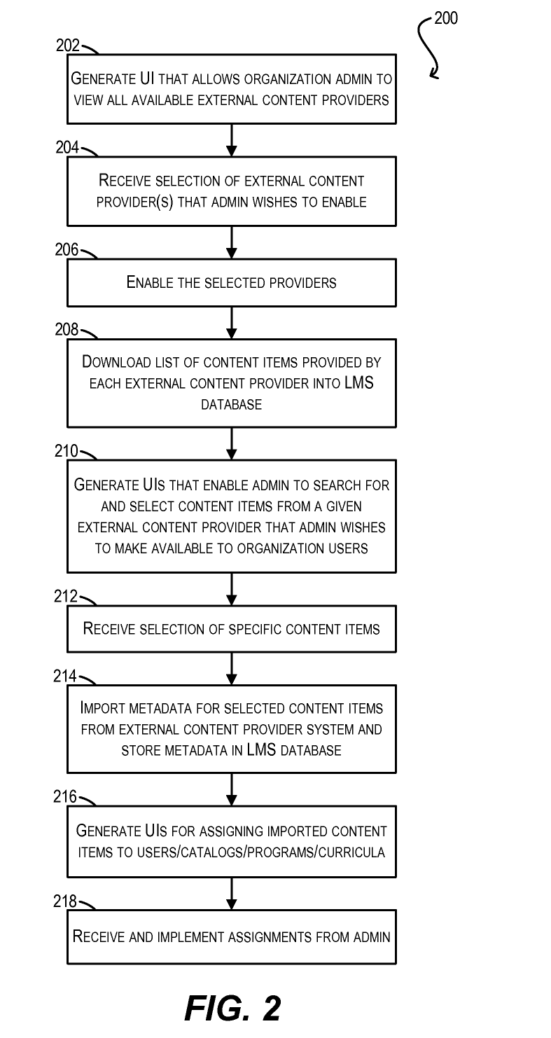

FIG. 2 depicts a flow 200 that can be performed by external catalog setup component 118 of OCN framework 116 for importing external learning content items into LMS 108 and making those external items available for search/access by organization users according to an embodiment.

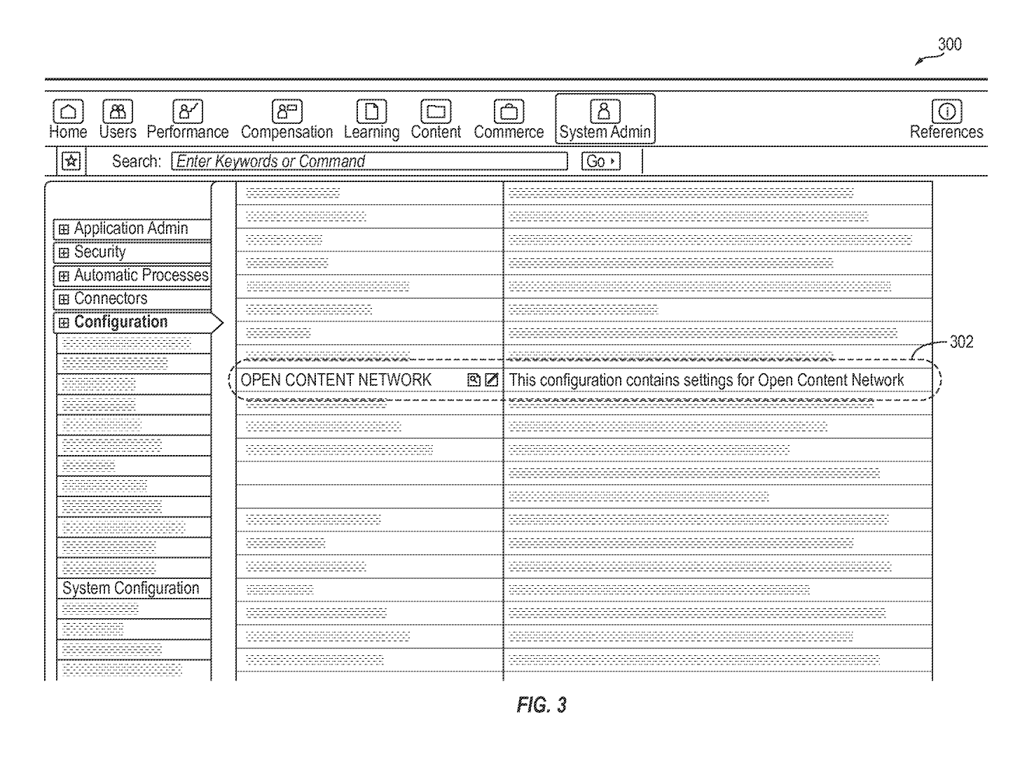

Starting with block 202, external catalog setup component 118 can generate a UI for an organization administrator that allows the administrator to enable external learning content and optionally view a list of external content providers (e.g., 114(1)-114(M) of FIG. 1) that have agreed to make their content available to organization users. These external content providers can include fee-based and free providers. FIG. 3 depicts an example of this UI (300), which includes an item 302 labeled “OPEN CONTENT NETWORK.” In this specific example, turning-on/configuring item 302 enables external learning content for all available content providers.

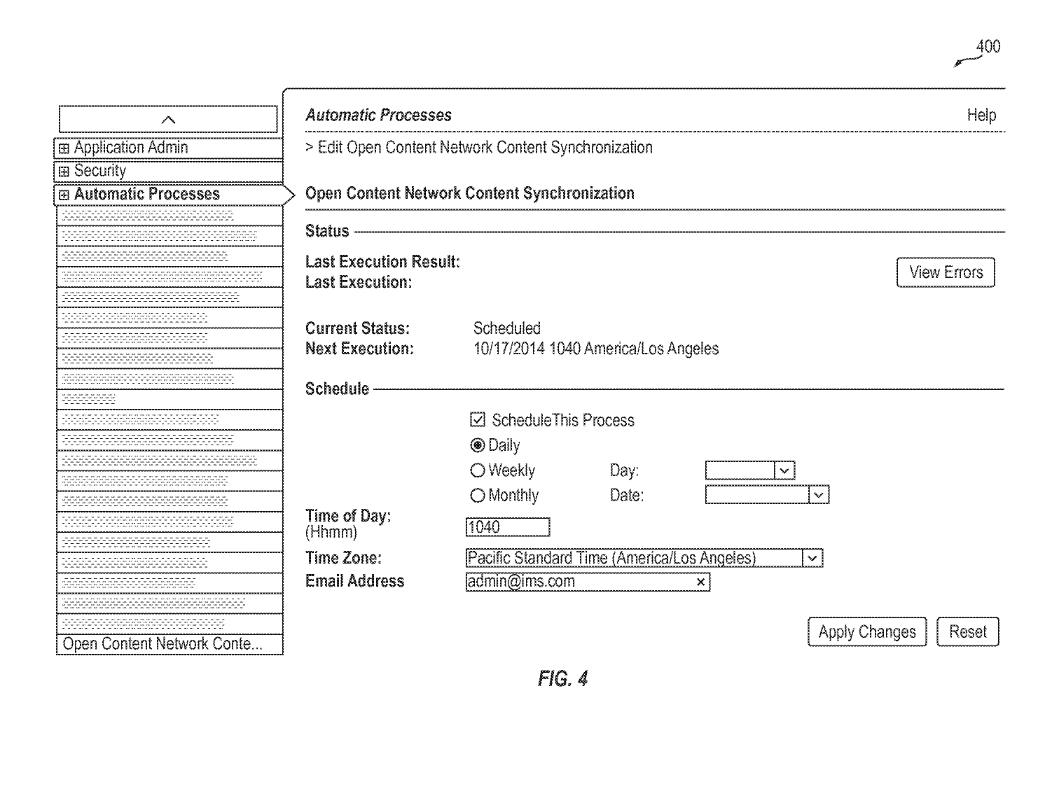

At block 204, the administrator can select the external content providers that the administrator wishes to enable for this LMS instance (assuming such a list was presented at block 202), and this selection can be received by external catalog setup component 118. For example, the administrator may choose to select, e.g., providers that offer free content, providers that the organization is contracted with, etc. As part of this step, the administrator can also configure certain properties associated with each selected external content provider, such as how course metadata for the provider is imported/synced, the URL for the provider, an internal provider ID, and more. For instance, FIG. 4 depicts an example “content synchronization” UI 400 for scheduling the retrieval of content metadata from the external content provider's system.

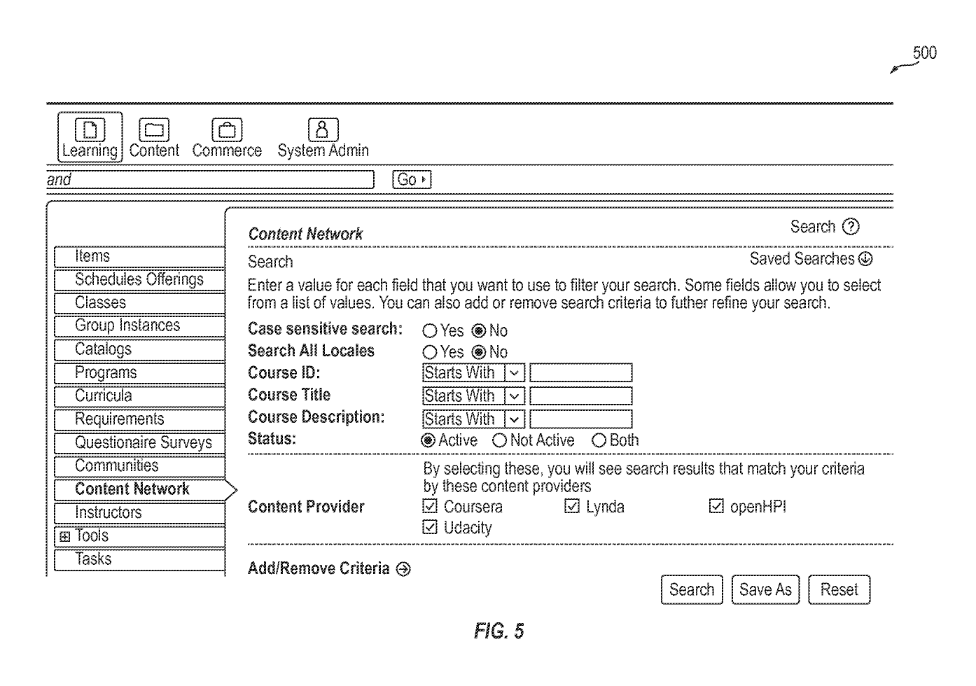

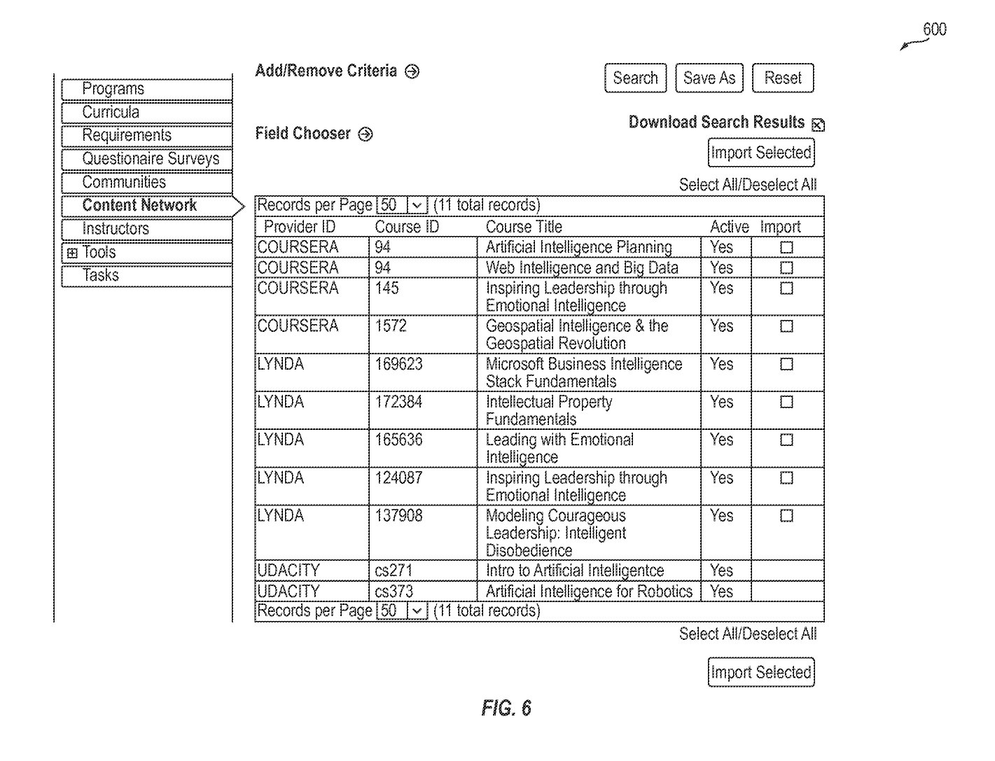

At block 206, external catalog setup component 118 can enable the external content providers selected at block 204. External catalog setup component 118 can then download a list of learning content items (e.g., courses, etc.) provided by each selected provider from the provider's system into an internal LMS database (block 208). External catalog setup component 118 can also generate UIs that enable the administrator to search for and select certain learning content items from a given external content provider that the administrator wishes to make available to organization users (block 210). For instance, FIG. 5 depicts an example search UI 500, and FIG. 6 depicts an example results UI 600 showing the results of the search entered via the UI of FIG. 5. In a particular embodiment, the administrator can search based on, e.g., title/description/category keywords, instructor name, content provider name/ID, content item IDs, content item titles, certification, language, etc.

At block 212, external catalog setup component 118 can receive a selection of one or more learning content items from the result list shown in FIG. 6. In response, external catalog setup component 118 can import metadata for the selected items from the external content provider's system and store the imported metadata in storage tier 106 (as, e.g., metadata 126 shown in FIG. 1) (block 214). The imported metadata can include, e.g., content provider ID, content item IDs, content item names, content item descriptions, and URLs or other pointers for accessing each learning content item.

Finally at blocks 216 and 218, external catalog setup component 118 can generate appropriate UIs, and receive appropriate administrator selections, for assigning the imported external learning content items to users or catalogs/programs/curricula in the LMS environment. In this way, those external learning content items will show up in the LMS system when users attempt to search for learning content.

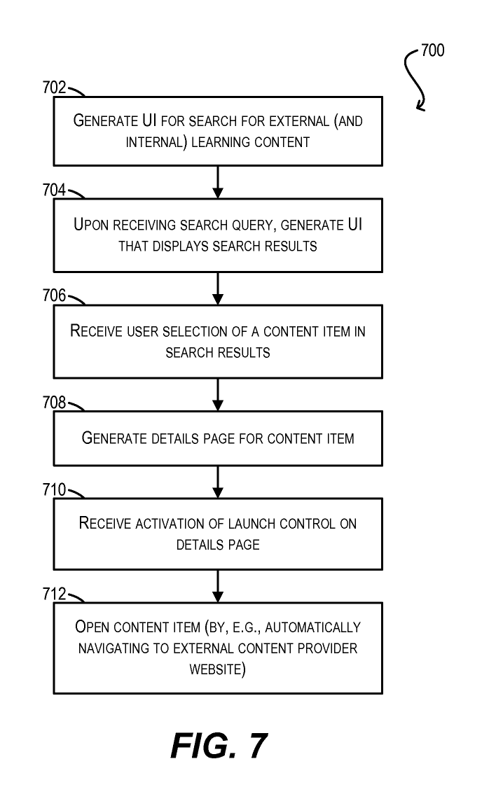

FIG. 7 depicts a flow 700 that can be performed by user search/launch component 120 of OCN framework 116 for enabling end-users to find and consume external learning content items that have been imported per flow 200 of FIG. 2 according to an embodiment.

Starting with block 702, user search/launch component 120 can generate a user-level UI for searching for external (as well as internal) learning content. The UI can include search criteria such as, e.g., item name, item category, item price, and item provider. Upon receiving a search query, user search/launch component 120 can generate a UI that shows the results of the search (block 704). Generally speaking, user search/launch component 120 will only return the external learning content items that have been assigned to the user, either directly or indirectly, via blocks 216 and 218 of FIG. 2.

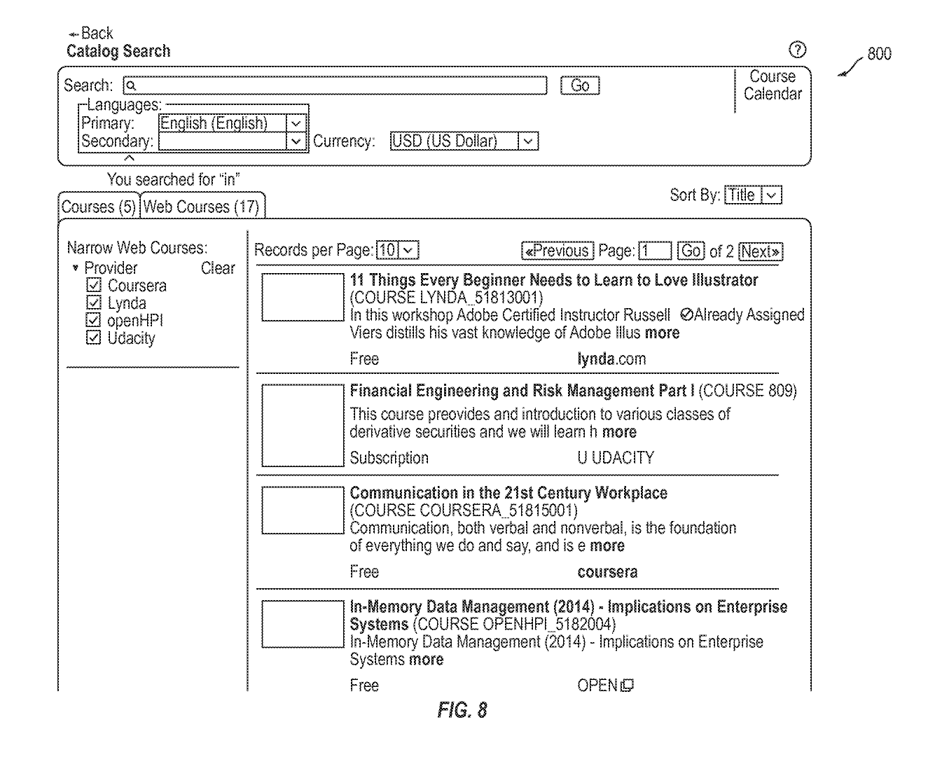

In one embodiment, the external learning content search results can be displayed on an individual “tab” in the UI that separates it from internal learning content results. For instance, FIG. 8 depicts an example UI 800 that shows the external learning content search results displayed on its own “Web Courses” tab. In other embodiments, the external learning content search results can be intermingled with internal learning content search results.

At block 706, user search/launch component 120 can receive a user selection of a particular learning content item included in the search results displayed at block 704. For example, with respect to the example UI of FIG. 8, the user may select the learning content item entitled “Financial Engineering and Risk Management Part I.” In response, user search/launch component 120 can generate a UI (e.g., a “details page”) that provides additional details regarding the selected content item (block 708). For instance, this “detail” UI may include a longer description of the item, schedule information, provider name/logo, price information, level (e.g., beginner, intermediate, advanced, etc.), length, language, supported platforms, and so on. In certain embodiments, this detail UI can also include controls for launching the learning content item and/or adding the item to a learning plan for the user.

Assuming that the user wishes to access the learning content item shown in the detail UI of block 708, user search/launch component 120 can receive an activation of the launch control associated with that item at block 710. This can cause user search/launch component 120 to open, either in the same window as the LMS search interface or a separate window, the selected content item (block 712). For example, if the learning content item is an online course available at a particular URL, user search/launch component 120 can automatically navigate to that URL and display the web page in the window. Finally, the user can consume/interact with the learning content item via the opened window.

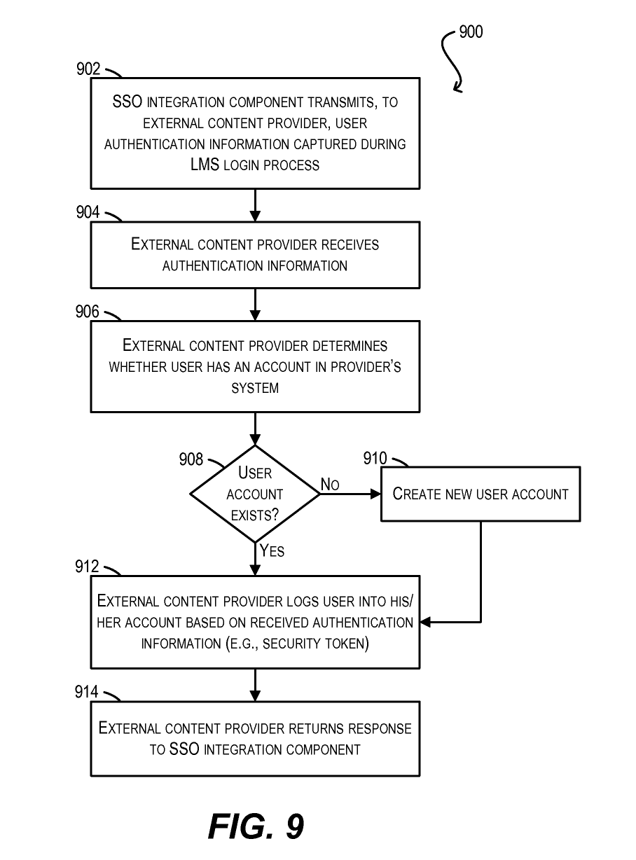

It should be noted that, as part of accessing the external learning content item at block 712, the external content provider may require that the user login to the external content provider's system with appropriate authentication credentials. FIG. 9 depicts a flow 900 that can be performed by SSO integration component 122 of OCN framework 116 for automating this login process according to an embodiment. Flow 900 assumes that the user has already logged into LMS 108 using a set of authentication credentials.

Starting with block 902, SSO integration component 122 can transmit, to the external content provider, authentication information for the user that was captured by an Identity Provider (IDP) associated with LMS 108 during the LMS login process. The IDP is an authentication platform that may be integrated into LMS 108 to facilitate user login, or may be a separate component from LMS 108. The authentication information transmitted at block 902 can include, e.g., the user's ID (e.g., email address), first name, last name, nickname, and/or organization name. The authentication information can also include a security token (e.g., a SAML-based token) that indicates the user has already been authenticated by the IDP.

At blocks 904 and 906, the external content provider can receive the authentication information and check, using the information, where the user has an account in the provider's system. If so, the external content provider can login the user based on the security token and return a successful authentication response to SSO integration component 122 (blocks 908 and 910).

On the other hand, if the user does not have an account in the provider's system, the external content provider can automatically create a new account for the user based on the received authentication information (blocks 908 and 910). The external content provider can then login the user using the new account (block 912) and return an appropriate response to SSO integration component 122 (block 914).

Thus, with flow 900, the user need only login once to LMS 108, and SSO integration component 122 can take care of logging the user into each external content provider system that the user wishes to access thereafter in the same LMS session. Further, new accounts can be created for the user on-the-fly, without requiring any manual intervention by the user.

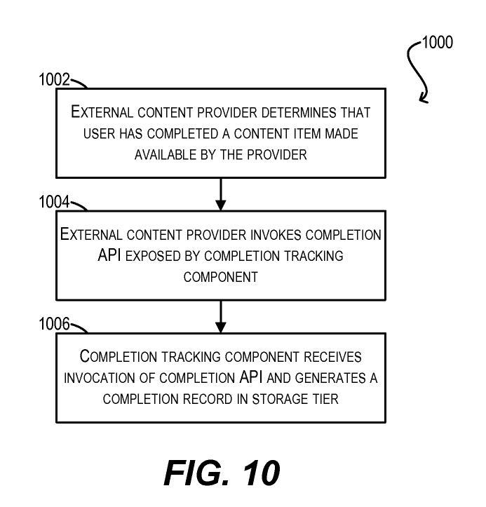

As noted previously, in certain embodiments, completion tracking component 124 of OCN framework 116 can integrate with external content providers to automatically create a record in LMS 108 when a user completes an external learning content item (e.g., course). This tracking can be useful for reporting, as well as helping users keep track of their learning history. FIG. 10 depicts a flow 1000 illustrating this integration according to an embodiment.

Starting with block 1002, an external content provider can determine when a user has completed a learning content item made available by the provider. For example, the external content provider may detect that the user has reached the end of a video lecture, or has successfully completed a test.

In response, the external content provider can invoke, e.g., a completion API exposed by completion tracking component 124 (block 1004). This API can include parameters that identify, e.g., the user, the content item that was completed, as well as other relevant data. In this embodiment, the API can have a standardized interface that is defined by the organization implementing completion tracking component 124 and can be made known to all external content providers. In other embodiments, the external content provider can provide this completion information to completion tracking component 124 using a standardized learning communication specification/protocol such as the Sharable Content Object Reference Model (SCORM) or the Aviation Industry Computer-Based Training Committee (AICC) specification.

Finally, at block 1006, completion tracking component 124 can receive the completion information and can generate a completion record for the user in storage tier 106. The completion record can be subsequently accessed as needed for reporting or record-keeping purposes.

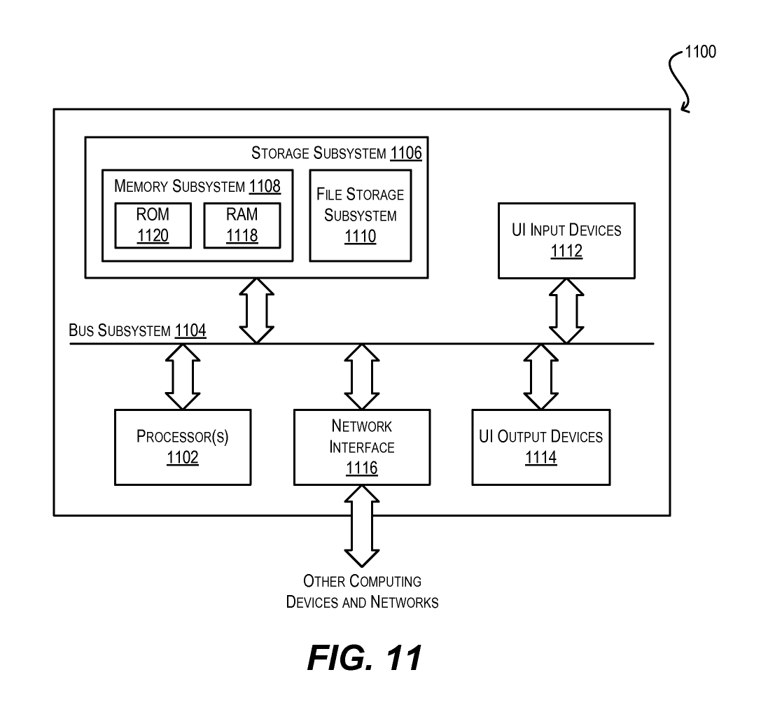

FIG. 11 depicts an exemplary computer system 1100 according to an embodiment. Computer system 1100 can be used to implement the various devices/systems described in the foregoing disclosure, such as the servers of server tier 104 and/or client devices 112(1)-112(N) of FIG. 1. As shown, computer system 1100 includes one or more processors 1102 that communicate with a number of peripheral devices via a bus subsystem 1104. These peripheral devices include a storage subsystem 1106 (comprising a memory subsystem 1108 and a file storage subsystem 1110), user interface input devices 1112, user interface output devices 1114, and a network interface subsystem 1116.

Bus subsystem 1104 can provide a mechanism for letting the various components and subsystems of computer system 1100 communicate with each other as intended. Although bus subsystem 1104 is shown schematically as a single bus, alternative embodiments of the bus subsystem can utilize multiple busses.

Network interface subsystem 1116 can serve as an interface for communicating data between computer system 1100 and other computing devices or networks. Embodiments of network interface subsystem 1116 can include wired (e.g., coaxial, twisted pair, or fiber optic Ethernet) and/or wireless (e.g., Wi-Fi, cellular, Bluetooth, etc.) interfaces.

User interface input devices 1112 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 1100.

User interface output devices 1114 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 1100.

Storage subsystem 1106 includes a memory subsystem 1108 and a file/disk storage subsystem 1110. Subsystems 1108 and 1110 represent non-transitory computer-readable storage media that can store program code and/or data that provide the functionality of various embodiments described herein.

Memory subsystem 1108 can include a number of memories including a main random access memory (RAM) 1118 for storage of instructions and data during program execution and a read-only memory (ROM) 1120 in which fixed instructions are stored. File storage subsystem 1110 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1100 is illustrative and not intended to limit embodiments described herein. Many other configurations having more or fewer components than computer system 1100 are possible.

The above description illustrates various embodiments along with examples of how aspects of those embodiments may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
importing, by a computer system into an organization's learning management system (LMS), metadata for external learning content items provided by an external content provider system;
assigning, by the computer system, each of the external learning content items to one or more users in the organization; and
enabling, by the computer system, the one or more users to search for and launch their assigned external learning content items via one or more user interfaces (UIs) of the LMS.

2. The method of claim 1 wherein the importing comprises:
receiving, from an organization administrator, a selection of the external content provider system from a list of external content provider systems;
retrieving, from the external content provider system, a list of available external learning content items;
receiving, from the organization administrator, a selection of one or more external learning content items from the list; and
importing metadata for the selected external learning content items from the external content provider system.

3. The method of claim 2 wherein the importing further comprises storing the metadata in a database associated with the LMS.

4. The method of claim 1 wherein the imported metadata includes, for each external learning content item:
a provider ID;
a content item ID;
a content item name;
a content item description; and
a resource locator.

5. The method of claim 1 wherein the assigning comprises:
generating a UI within the LMS listing the external content items; and
receiving, from an organization administrator, an assignment of one or more of the external learning content items to a program, curriculum, or catalog defined within the LMS and associated with the organization's users.

6. The method of claim 1 wherein the enabling comprises:
generating a first UI within the LMS for searching for the external learning content items;
receiving, from a user, a search query in response to the first UI;
executing the search query against the imported metadata; and
generating a second UI within the LMS identifying external learning content items that match the user's search query.

7. The method of claim 6 wherein the first UI is configured to also allow searching for internal learning content items that have been internally developed by the organization.

8. The method of claim 6 wherein the enabling further comprises:
generating, in response to a user selection of an external learning content item in the second UI, a third UI within the LMS displaying detailed information regarding the external learning content item, the third UI including a launch control for launching the external learning content item.

9. The method of claim 8 wherein the enabling further comprises:
detecting an activation of the launch control; and
automatically launching the external learning content item within the third UI or a separate window of the LMS.

10. The method of claim 9 wherein automatically launching the external learning content item comprises:
retrieving the metadata for the external learning content item imported from the external content provider system;
determining a resource locator associated with the external learning content item from the metadata, the resource locator pointing to the external content provider system; and
accessing the resource locator.

11. The method of claim 9 wherein automatically launching the external learning content item comprises:
transmitting, to the external content provider system, authentication information for the user determined at a time the user logged into the LMS.

12. The method of claim 11 wherein the authentication information includes a username, an organization name, and a security token.

13. The method of claim 12 wherein the external content provider system is operable to, in response to receiving the authentication information:
determine whether the user has an existing account within the external content provider system based on the authentication information; and
if the user has an existing account, automatically log the user into the existing account using the security token.

14. The method of claim 13 wherein, if the user does not have an existing account, the external content provider system is operable to:
create a new account for the user; and
automatically log the user into the new account.

15. The method of claim 9 wherein the external content provider system is operable to, upon detecting completion of the external learning content item by the user:
invoke an application programming interface (API) for recording the completion of the external learning content item within the LMS.

16. A non-transitory computer readable storage medium having stored thereon program code executable by a processor, the program code comprising:
code that causes the processor to import, into an organization's LMS, metadata for external learning content items provided by an external content provider system, the importing comprising storing the metadata in a database associated with the LMS;
code that causes the processor to assign each of the external learning content items to one or more users in the organization; and
code that causes the processor to enable the one or more users to search for and launch their assigned external learning content items via one or more UIs of the LMS.

17. The non-transitory computer readable storage medium of claim 16 wherein the program code further comprises:
code that causes the processor to transmit authentication information for a user to the external content provider system at a time the user launches an external learning content item; the authentication information including information determined at a time the user logged into the LMS.

18. The non-transitory computer readable storage medium of claim 17 wherein the program code further comprises:
code that causes the processor to receive an invocation of a completion API from the external content provider system when the external content provider system detects that the user has completed the external learning content item; and
code that causes the processor to store a completion record for the user in a database of the LMS.

19. A computer system comprising:
a processor;
a memory; and
a non-transitory computer readable storage medium having stored thereon program code that, when executed by the processor, causes the processor to:
import, into an organization's LMS, metadata for external learning content items provided by an external content provider system;
assign each of the external learning content items to one or more users in the organization; and
generate a first UI within the LMS for searching for the external learning content items;
generate a second UI within the LMS displaying detailed information regarding an external learning content item selected by a user, the second UI including a launch control for launching the external learning content item;
detect an activation of the launch control; and
automatically launch, within the second UI or a separate window of the LMS, the external learning content item by accessing a resource locator for the external learning content item that points to the external content provider system,
wherein, as part of launching the external learning content item, the processor transmits authentication information for the user to the external content provider system, the authentication information including a username and an organization name determined at a time the user logged into the LMS.

20. The computer system of claim 19 where the program code further causes the processor to:
receive an invocation of a completion API from the external content provider system when the external content provider system detects that the user has completed the external learning content item; and
in response to the invocation, store a record for the user in a database of the LMS indicating completion of the external learning content item.
